(19) United States
(12) Patent Application Publication
(10) Pub. No.: US 2011/0101266 A1
(43) Pub. Date: May 5, 2011

(54) REINFORCEMENT STRUCTURES

(75) Inventors: David James Thomas, Swansea (GB); Rebecca Louise Thomas, Suffolk (GB); Benjamin James Thomas, London (GB)

(73) Assignee: Co-Tropic Limited, Haverhill, Suffolk (GB)

(21) Appl. No.: 12/441,787

(22) PCT Filed: Sep. 18, 2007
(86) PCT No.: PCT/GB2007/003534

§ 371 Date: Nov. 13, 2009

(30) Foreign Application Priority Data
Sep. 19, 2006 (GB) 0618463.4

(51) Int. Cl. B29C 70/04; E04C 5/00; B28B 23/02; B29B 7/90

(52) U.S. Cl. 252/182.11; 428/357; 428/369; 428/371; 428/66.6; 428/398; 428/397

(57) ABSTRACT

The invention relates to the reinforcement of materials by the dispersal of structures in the material to be reinforced. In particular the invention relates to the reinforcement of materials and involves the random dispersal of independent three-dimensional structures in the material, these structures may be a mixture of left and right handed structures and/or comprise a series of lumen to anchor them into the material and/or be selected from a subset of possible three dimensional structures based on the number of apices and connections between these.

### FIELD OF THE INVENTION

The invention relates to the reinforcement of a material by the dispersal of structures in the material to be reinforced. In particular the invention relates to the reinforcement of concrete and involves the random dispersal of independent three-dimensional structures in concrete.

### BACKGROUND OF THE INVENTION

Modern building techniques use a variety of materials to create modern large-scale construction projects. One of the most important material is concrete and concrete forms the basis for most modern structures and performs a number of independent support, reinforcement and structural roles in a variety of environments. The main benefit of concrete is its strength and rigidity when compressed and its ability to be made up as a fluid which can be easily applied and formed into many structural shapes or forms. Other materials that have these properties and are used in modern building techniques include resins, polymers, ceramics and bitumen.

In their most basic form composite materials are a matrix e.g. concrete, polymer, resin, ceramic, metal, bitumen with reinforcing agents (e.g. fibres, whiskers, particulate, mesh, grid work, or preform) embedded in the matrix. Composite materials offer important benefits over conventional materials, including high specific strength and stiffness.

A composite material is a material system consisting of a mix or combination of two or more micro or macro-constituents that differ in form and chemical composition, and which are to all intents and purposes insoluble in each other. The engineering importance of composite materials is that two or more markedly different materials are combined to produce a composite material possessing properties that are in some way advantageous to those of the individual components. The use of reinforcement for concrete, polymer resin, bitumen, masonry and similar gel type materials is well known and has been reported in the literature.

Although concrete has a high amount of structural rigidity and strength, in order to be useable in certain roles it is necessary to further reinforce these materials. As indicated above concrete has a high compressed strength, but in comparison it has relatively low tensile strength and therefore failure of concrete structures is most normally due to these poor tensile properties. It has been shown that by the introduction of materials with a higher tensile strength into concrete as it is cast, these embedded reinforcing materials can improve the overall properties of the concrete structure.

Modern concrete structures are usually made with some sort of reinforcement. Concrete can be susceptible to cracking as the structure is subjected to bending loads and/or impact. Weathering is also a contributing factor to spalling. This type of failure is mainly owing to the poor tensile properties of the concrete. The characteristics of concrete that have conditioned its development as a structural material are its high compressive strength and its relatively low tensile strength. In consequence its use for flexural members did not become practicable until it was discovered that steel reinforcement could be cast in the concrete to carry the bending tensile stresses whilst relying on the concrete to carry the bending compressive stresses'. (Ref Civil Engineer's Reference Book edited by L S Blake Newnes-Butterworths, London, with specialist contributor, S C C Bate, Building Research Establishment pp 11-2 to 11-69.

At the present time the most common way of reinforcing a concrete structure is to use a number of reinforcement bars sometimes in the form of a lattice or alternatively in the form of a number of substantially parallel longitudinal members projecting through the concrete structure. These bars, whether in the form of a lattice or in a parallel arrangement, are generally spaced at regular intervals and so the overall tensile strength properties of the reinforced concrete block are relatively uniform. This type of reinforcement bar is used in pre-set grid work commonly known as REBAR.

Significant problems exist with REBAR type reinforcement, as although an increase in the tensile strength of a concrete structure is achieved, the concrete structure is still lacking in tensile strength particularly in the regions between the reinforcing bars. In addition, it is also possible that the concrete structure can be reinforced inappropriately by providing the reinforcement members in a position or pattern inappropriate to the specific load that is to be placed upon the structure.

For reinforcement purposes foundations, paving, roadways, driveways, and airport runways are sometimes considered as inverted cantilevers and beams with ground pressure providing an upward support. Ground erosion at the edges of a roadway or subsidence anywhere underneath can lead to reduced ground support and alter the type of stress within the surfacing medium. Unacceptable, ground upheaval owing to minor earthquake disturbance or root protrusion (the insidious pressure from tree roots) can also alter the type of stress within the surface medium and lead to extensive damage of the roadway. Alternatively damage can occur by ground erosion at the edges of the structure causing different tensions to act upon the concrete structure than was intended at the time of its creation.

An alternate means of reinforcing a structure that is relatively weak to tensile forces is via the introduction of a number of one, two or three-dimensional structures during the manufacture of such a material. Such techniques are particularly used in the manufacture of bricks and concrete blocks so as to increase the tensile properties of these. In general this second type of reinforcement means although utilising a different set of structures operates in a similar fashion to other reinforcement means in that the reinforcing structures are not free to disperse throughout the material but instead are located in pre-set positions in the final structure.

These reinforcement structures may be made from a wide variety of materials and made into a variety of shapes. For instance fibre-reinforced polymer composites comprising resin polymer matrix material the most common being polyester, vinylester and epoxy. Or more substantial and rigid structures made of materials such as steel or other rigid materials.

Significant problems exist with the clumping of these structures if they are allowed to freely disperse throughout the material being reinforced due to the very similar physical properties of the structures and the concomitant interaction of these physical features which allow their clumping.

There will now be discussed further examples of prior art reinforcement means and the disadvantages associated with these.

Asphalt

Bitumen is a black sticky substance derived from processing crude oil deposits. When mixed with stone aggregate, whether by natural occurrence or expressly man-made are referred to as asphalts. (Bitumen is also known as asphaltic cement mainly in North America). Bitumen becomes fluid when heated and when in this state can be readily applied during road making.

Masonry

The use of masonry products such as bricks, stone, concrete blocks etc are weak in tension their use is limited to situations where they primarily remain in compression. Wind loading means that tensile stresses can be imposed on large walls area, which limits the unsupported span that can be achieved by conventional brickwork and concrete work. The addition of dispersible, three-dimensional shaped, structures during the manufacture of bricks and concrete blocks will improve their tensile properties. The strength of the mortar used can be adjusted as necessary but it is usual that the mortar is made with less tensile strength than the bricks and concrete blocks they join. This is preferred so as to avoid failure of the bricks during settlement or extremes of temperature. Reinforced brick and concrete blocks with lead to improved tensile properties, and would therefore, would enable mortar strength to be more effectively utilised.

The prior art has explored various aspects of application of reinforcement methods and devices:

The use of structural members for reinforcement of asphalt and concrete roadways and other products and which comprises a grid-work of warp and weft strands which are disposed at right angles to each other and so define an open o structure is disclosed by James e. Hendrix, L. Brown, Jr., and Mansfield H. Creech, Jr., in U.S. Pat. No. 6,632,309 B1, published Oct. 14, 2003. This type of reinforcement is strategically placed in a pre-set position, but it is not a dispersible or mixable type of reinforcement.

The use of wide-meshed, textile lattice to provide reinforcement for bitumen-bonded layers, of width wide enough for road surfacing, as a means of preventing the occurrence of tearing and the propagation of tearing in the layers of asphalt is taught by Jurgen Kassner, Heiko Printz, and Ulrich Von Fransecky in U.S. Pat. No. 6,503,853 B1, published, Jan. 7, 2003. This type of reinforcement is strategically placed in a pre-set position, but it is not a dispersible or mixable type of reinforcement.

The prior art have explored various aspects of the application of whisker type reinforcement. Klaus-Alexander Rieder, Neal S. Berke, Michael B. Macklin, Anandakumar Ranganathan and Salah Altoubat. In U.S. Pat. No. 6,569,526 B2, published May 27, 2003, discloses ‘Highly Dispersible Reinforcing Polymeric Fibres’. These inventors describe—Synthetic polymer reinforcing fibres that provide dispersability and strength in matrix materials such as concrete, masonry, shotcrete, and asphalt. The individual fibres have generally quadrilateral cross-section. This type of reinforcement is dispersible or mixable, but is regarded as one-dimensional in function. It is essential that these fibres are properly and thoroughly dispersed throughout the matrix material and are not allowed to ‘clump’ and create fibre-free regions.

Use of whisker type carbon fibres (25 to 30 mm or more in length) as an alternative method of reinforcement of concrete is taught by Yoshikazu Nagata, Katsumi Takano, Toshio Yonezawa, Junichi Ida, and Masaki Iwata, U.S. Pat. No. 5,652,058, ‘Carbon Fibre Rovings for Reinforcement of Concrete’, published Jul. 29, 1997. This carbon fibre reinforcement patent teaches that carbon fibres have certain advantages over asbestos fibres (carcinogen), glass fibre (deteriorates in cement), and organic fibres (poor in fire resistance). The poor adhesive properties of the carbon fibre in bonding to the cement and the problem that these fibres cannot, therefore, exert a sufficient effect, as the reinforcement material without special care is well known. This patent teaches monofilament strands can be are bundled (5-100 strands) into one roving to provide excellent adhesive properties to cement. This type of reinforcement is dispersible or mixable, but essentially only provides a limited two-dimensional function.

Traditionally reinforcement bar has been designed to present a cross-section of varying profile thus providing a better key for the matrix material to cling to. Essentially, a regular series of obtrusions have been formed to allow for greater adhesion.

Use of shallow re-entrant features formed onto the fibre reinforcement to increase the surface area and hence the bond strength between the fibre and the matrix material are taught by A E Naaman U.S. Pat. No. 6,060,162, ‘Optimised geometries of fibre reinforcement of cement, ceramic and polymeric based composites’ published May 9, 2000. This type of reinforcement is dispersible and mixable, but essentially only provides a limited two-dimensional function. Moreover, the geometries described are unable to provide an interlock (dovetail) effect.

Use of a one piece three-dimensional perform reinforcement is taught by Kikuo Nakano, and Akira Kamiya, U.S. Pat. No. 5,660,863, Apparatus for the production pf Ceramics reinforced with three-dimensional fibers, published Aug. 26, 1997. These investigators teach that, The one-dimensional fibre reinforcing type manifest tensile and flexural strength sufficiently in the direction of the fibres but only meagrely in the directions at or near perpendicular to the direction of the fibre reinforcement. The two-dimensional fibre reinforcing type exhibits great strength in the plane containing the fibres but poor strength in the direction perpendicular to the plane. In contrast, the three-dimensional fibre reinforcing type shows strength virtually uniformly in an isotropic manner in all directions. The three-dimensional fibre reinforcing type is therefore ideal for the purpose of reinforcement’. This type of reinforcement provides three-dimensional reinforcement in the form of a single perform unit, but it is not designed to be dispersible, mixable or interpenetrating with other dispersible three-dimensional reinforcement structures.

The inventors seeing the problems associated with the prior art and specifically problems associated with the need to, as far as possible, evenly distribute the reinforcement across the entirety of the concrete structure and, more specifically, the disadvantages seen with many types of current reinforcement means wherein a substantial number of the reinforcing structure clump together have arrived at a new solution to the reinforcement of concrete and other materials.

### SUMMARY OF THE INVENTION

According to a first aspect of the present invention there is provided a reinforcement means which comprises a plurality of substantially identical structures, the reinforcement means is characterised in that this plurality of structures comprise a mixture of right and left hand structures.

In accordance with this first aspect of the present invention, the inventors provide reinforcement means that comprises a plurality of substantially identical structures. The structures are substantially identical in terms of their physical shape and dimensions. By providing reinforcement means comprising such a plurality of similarly sized and shaped structures, this allows the structures to be fabricated en-mass so reducing production costs. In accordance with this first aspect of the present invention, the invention is characterised in that this plurality of substantially identical structures comprises a mixture of right and left handed structures. All three-dimensional structures are capable of having handedness, this is the presence of mirror images of a three-dimensional structure, one corresponding to a right handed version of said structure and one corresponding to a left handed version of said structure.

By providing reinforcement means which comprise a plurality of reinforcing structures in a mixture of left and right handed versions, this reduces the likelihood of these structures clumping together. Unlike in a mixture where all of o the structures are of a single handedness it is not possible for a left and a right handed structure to interpose with each other in the same way as two identical handed structures. Therefore, this reduces the likelihood of clumping of the individual structures that make up the reinforcement means.

This increases the likelihood that the plurality of structures will be dispersed evenly throughout the substance being reinforced, so increasing the homogeneity of reinforcement across the reinforced structure improving its properties and decreasing the likelihood of localised failure due to tensile or other stress.

Preferably, each of this plurality of structures is substantially rigid.

By providing a plurality of substantially rigid structures, the tensile strength of the substance being reinforced is substantially increased. It is more likely that as the plurality of structures is dispersed throughout the material which is being reinforced that the plurality of structures will maintain their three-dimensional shapes so affecting a greater proportion of the material to be reinforced on a per structure basis than would be the case if the plurality of structures were compressed or deformed as a result of their mixture throughout the material.

Preferably, the plurality of structures comprises a plurality of one-dimensional structures fabricated so as to extend into three dimensions.

A simple reinforcement structure that may be mass-produced for a limited cost is a piece of wire that is a substantially one-dimensional structure. Such a piece of wire may be fabricated so as to extend into three-dimensions by introducing into such a piece of wire a number of bends. In this way a simple substantially one-dimensional structure can be fabricated so as to exert a reinforcing effect in three-dimensions. Also, given the three-dimensional structure of this substantially one-dimensional member, a mixture of left and right handed structures can be fabricated which are substantially identical in all but their handedness.

Preferably, the substantially one-dimensional member may comprise an open form.

In accordance with this further aspect of the present invention, the substantially one-dimensional member may be in an open form, this means the first and second end of the substantially one-dimensional structure are not linked or joined to either this same substantially one-dimensional member or another structure.

Alternatively, the substantially one-dimensional member may comprise a substantially closed loop arrangement.

In the alternative instead of the substantially one-dimensional member having ends, which are not joined to itself or another structure, the substantially one-dimensional member may be fabricated into a closed loop structure again projecting in three-dimensional space. This type of closed loop arrangement would endow the structure with greater structural strength and rigidity.

Preferably the substantially one-dimensional member may comprise a substantially helical form.

By forming the substantially one-dimensional member into a helical form, this provides the structure with a regular and repeated structure over an extended longitudinal dimension. In addition, by being in a helical form the structure which makes up the reinforcement means can be extended and compressed in a number of directions without compromising the overall structural properties of the helical form.

Preferably, the reinforcement means may comprise at least one lumen and an associated aperture, characterised in that the maximum dimension of the at least one lumen is greater than the maximum dimension of the associated aperture.

In addition to providing a plurality of structures in a mixture of right and left handed versions, the inventors also consider it possible to further increase the reinforcement of a substance by providing at least one lumen or reservoir formed into one or all of these plurality of structures and associated with this lumen an aperture.

This aspect of the invention being characterised in that the maximum dimension of these lumen is greater than the maximum dimension of its associated aperture. In this way, when the reinforcement means and specifically one of the said at least one lumen is within a substance which is to be reinforced and specifically the substance has entered into the lumen, this substance will solidify inside of the lumen. This bolus of solidified material will then be incapable of passage from the lumen via the associated aperture so embedding and anchoring the reinforcement means further into the substance that is to be reinforced.

Preferably the reinforcement means may comprise a plurality of lumen.

By providing a plurality of lumen the previously described re-entrant effect of these lumen upon the reinforcement means and material the reinforcement is increased and the structures are anchored in place.

Preferably each of the at least one lumen is substantially enclosed by the material into which it is formed upon the reinforcement means and is accessible only via said associated aperture.

By providing a completely enclosed lumen this means that the solidified bolus of material contained within the lumen can only exit the lumen via its associated aperture, so increasing the anchoring effect of the lumen upon the reinforcement means.

Preferably each of the at least one lumen is substantially open and comprises more than one associated aperture, wherein a maximum dimension of each of the at least one lumen is greater than a maximum dimension of the associated apertures only in one plane.

By providing a lumen that is substantially open this would increase the speed with which this lumen would fill with material which would then be able to solidify in place. The disadvantage of such an arrangement is that such material would be free to move out of the lumen except at the aperture. The device is configured such that in at least one plane the maximum dimension of the lumen is greater than the maximum dimension of its associated aperture. So if material was to attempt to leave the lumen in this way it would be prevented from doing so as the maximum dimension of the aperture is less than the maximum dimension of the lumen and as a result of this the solidified material contained therein.

Preferably the closed structures define a three-dimensional geometric shape, wherein this three-dimensional geometric shape is characterised in that the shape comprises at least four apices and wherein each of the apices is connected to at least three other of the apices by at least one substantially one-dimensional member.

The inventors through their research have identified a class of three-dimensional structures that they consider to be particularly suitable for use in this reinforcing means. The structures comprise at least four apices, each of these apices being connected to at least three other of the apices via at least one substantially one-dimensional member between each apex.

The inventors have, through their research, identified a number of three-dimensional structures that are particularly appropriate to functioning as component structures of this reinforcement means. In particular the inventors consider geometric shapes comprising at least four apices and wherein each of these four apices is connected to at least three other of the apices by at least one substantially one-dimensional member to be the most appropriate rule set for identifying shapes.

Preferably, the three-dimensional geometric shape is regular comprising substantially uniform sides.

Shapes with substantially uniform sides, for instance, shapes comprising only triangles or squares are considered suitable for the implementation of this invention.

In particular, the three-dimensional geometric shape may be a three-sided pyramid.

Alternatively, the three-dimensional geometric shape may be a cuboid.

Alternatively, the three-dimensional geometric shape may be irregular and comprise side portions that are not uniform and may comprise different numbers of sides.

Therefore, in addition to using structures with regular uniform sides it is also possible to implement the invention by using three-dimensional shapes with irregular sides which may differ from each other in terms of dimensions and/or the number of sides to each side.

Preferably, third three-dimensional geometric shape may be a four sided pyramid.

Preferably, the substantially one-dimensional members which join the apices of the three-dimensional structure may define planar sides of the three-dimensional geometric shape.

Preferably, the reinforcement means may comprise a mixture of different sized structures.

In addition to the reinforcement means comprising a plurality of structures of a single size it is also possible and sometimes advantageous to provide a mixture of different size structures of similar or different three-dimensional shapes.

Preferably the reinforcement means are configured to be used with concrete.

Alternatively, the reinforcement means is configured for use with a resin.

Alternatively, the reinforcement means is configured for use with asphalt.

Alternatively, the reinforcement means is configured for use with polymer materials.

Alternatively, the reinforcement means is configured for use with a gel material.

According to a further aspect of the present invention there is provided a method of reinforcing material comprising the introduction of a plurality of substantially identical structures into said material, the method being characterised in that the plurality of structures comprise a mixture of rights and left handed structures.

In accordance with a further aspect of the present invention there is provided a kit of parts for the reinforcing means, this kit of parts comprising a plurality of substantially identical structures, characterised in that this plurality of structures comprises a mixture of left and right handed structures.

According to a second aspect of the present invention there is provided a reinforcement means comprising at least one lumen and an associated aperture characterized in that a maximum dimension of said at least one lumen is greater than a maximum dimension of said associated aperture.

Preferably said at least one lumen and said associated aperture is formed into a substantially two dimensional structure.

Preferably said substantially two dimensional structure is in the form of a disc.

Preferably said lumen is formed into a substantially elongate member.

Preferably said substantially elongate member is formed into a three dimensional structure.

Preferably the reinforcement means comprises a plurality of said three dimensional structures, characterised in that said plurality of structures comprises a mixture of left and right handed structures.

Preferably each of said plurality of structures is substantially rigid.

Preferably said three dimensional structure comprises a substantially one dimensional member fabricated into a three dimensional form, the ends of which are not connected.

Preferably said three dimensional structure is fabricated from a substantially one dimensional member into a closed loop three dimensional structure.

Preferably said one dimensional member comprises a helical form.

Preferably said reinforcement means comprises more than one lumen.

Preferably each of said at least one lumen is substantially enclosed by the material into which said at least one lumen is formed and entry into said at least one lumen is only possible via said associated aperture.

Preferably said at least one lumen is substantially open, and wherein said maximum dimension of said at least one lumen is greater than a maximum dimension of said associated aperture in a single dimension.

Preferably the reinforcement means, comprises a three dimensional geometric shape characterized in that said shape comprises at least four apices and wherein in each of said apices is connected to at least three other of said apices by at least one substantially one dimensional member.

Preferably said three dimensional geometric shape is a regular geometric shape comprising side portions of equivalent dimension.

Preferably said regular geometric shape is a four sided pyramid.

Preferably said three dimensional geometric shape is a cuboid.

Preferably said three dimensional geometric shape is irregular wherein the sides of said irregular geometric shape comprising side portions with sides which are not equivalent.

Preferably said one dimensional members defines substantially planar sides of said three dimensional geometric shapes.

Preferably the reinforcement means, comprises a plurality of different sized three dimensional geometric shapes.

Preferably said reinforcement means is configured for use with concrete.

Preferably said reinforcement means is configured for use with resin.

According to a further aspect of the present invention there is provided a method of reinforcing a material, comprising the use of reinforcement means, said reinforcement means comprising at least one lumen and an associated aperture, characterized that in a maximum dimension of said at least one lumen is greater than a maximum dimension of said associated aperture.

According to a further aspect of the present invention there is provided a kit of parts for a reinforcement means, wherein said reinforcement means comprises at least one lumen and an associated aperture, characterized in that a maximum dimension of said at least one lumen is greater than a maximum dimension of said associated aperture.

Preferably said maximum dimension of said at least one lumen and said maximum dimension of said associated aperture are measured in the same plane.

According to a further aspect of the present invention there is provided a reinforcement means comprising a three dimensional geometric shape, characterized in that said shape comprises at least four apices and wherein each of said apices are connected to at least three other of said apices by at least one substantially one dimensional member.

Preferably said three dimensional geometric shape is substantially rigid.

Preferably said three dimensional geometric shape is regular comprising side portions of substantially equal dimension.

Preferably said three dimensional geometric shape is a four sided pyramid.

Preferably said three dimensional geometric shape is a cuboid.

Preferably said three dimensional geometric shape is irregular comprising sides which are not of equivalent dimension.

Preferably said at least one substantially one dimensional members define substantially planar sides to said three dimensional geometric shape.

Preferably said three dimensional geometric shape comprises at least one lumen and an associated aperture, characterized in that a maximum dimension of said at least one lumen is greater than a maximum dimension of said associated aperture.

Preferably the reinforcement means comprises more than one lumen.

Preferably said at least one lumen is substantially enclosed by the material into which it is formed and entry to each of said at least one lumen is via said associated aperture.

Preferably said at least one lumen is substantially open to the environment.

Preferably the reinforcement means comprises a plurality of three dimensional geometric shapes, characterized in that said plurality of three dimensional generic shapes comprises a mixture of right and left handed structures.

According to a further aspect of the present invention there is provided a method of reinforcing a material comprising the use of reinforcement means comprising at least one three dimensional geometric shape, characterized in that said shape comprises at least four apices and wherein each of said apices is connected to at least three other of said apices by at least one substantially one dimensional member.

According to a further aspect of the present invention there is provided a kit of parts for a reinforcement means comprising a three dimensional geometric shape, characterized in that said shape comprises at least four apices and wherein each of said apices is connected to at least three other of said apices by at least one substantially one dimensional member.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 shows a reinforcement means according to a first specific embodiment of the present invention.

FIG. 2 shows a plurality of reinforcement means according to a first embodiment of the present invention.

FIG. 3 shows a plurality of reinforcement means according to the first invention of various sizes.

FIG. 4 shows a reinforcement means according to a second specific embodiment of the present invention.

FIG. 5 shows a reinforcement means according to a third specific embodiment of the present invention.

FIG. 6 shows a reinforcement means according to a fourth specific embodiment of the present invention.

FIG. 7 shows a reinforcement means according to a fifth specific embodiment of the present invention.

FIG. 8 shows a reinforcement means according to a sixth specific embodiment of the present invention.

FIG. 9 shows a reinforcement means according to a seventh specific embodiment of the present invention.

FIG. 10 shows a reinforcement means according to a eighth specific embodiment of the present invention.

FIG. 11 shows a plurality of reinforcement means according to a further specific embodiment of the present invention.

FIG. 12 shows a reinforcement means according to a ninth specific embodiment of the present invention.

FIG. 13 shows a reinforcement means according to a twelfth specific embodiment of the present invention.

FIG. 14 shows a reinforcement means according to a eleventh specific embodiment of the present invention.

FIG. 15 shows a reinforcement means according to a thirteenth specific embodiment of the present invention.

FIG. 16 shows a reinforcement means according to a fourteenth specific embodiment of the present invention.

FIG. 17 shows a reinforcement means according to a fifteenth specific embodiment of the present invention.

FIG. 18 shows a reinforcement means according to a sixteenth specific embodiment of the present invention.

FIG. 19 shows a reinforcement means according to a seventeenth specific embodiment of the present invention.

FIG. 20 shows a reinforcement means according to an eighteenth specific embodiment of the present invention.

FIG. 21 shows a reinforcement means according to a further specific embodiment of the present invention.

### DETAILED DESCRIPTION

There will now be described by way of example a specific mode contemplated by the inventors. In the following description numerous specific details are set forth in order to provide a thorough understanding. It will be apparent however, to one skilled in the art, that the present invention may be practiced without limitation to these specific details. In other instances, well-known methods and structures have not been described in detail so as not to unnecessarily obscure the description.

Dispersible/Mixable, Three-Dimensional Shaped, Reinforcement Structures.

It is an object of this invention to provide a novel dispersible/mixable, three-dimensional shaped, space cells, (e.g. regular and irregular triangular based pyramids, polygon based pyramids, conical shaped, wedge shaped, pyramidal frustums, conic frustums, wedge frustums, spherical shapes, cylindrical shaped mesh, or similar tubular oval or polygonal shaped mesh, left and right handed helical coil shaped and left and right hand ‘Mobius’ shaped mesh strips). Manufactured from wire, bar, rod, tube, or fibre, for reinforcement structures; or similar three-dimensional shaped dispersible/mixable open structures (e.g. corrugated mesh, twisted mesh, double ‘U’ shaped mesh and spurs) that will help to prevent cracks from developing in gel type materials such as, concrete, asphalt, polymer, resin composite etc by reinforcing in three directions.

It is a further object that the introduction of such three-dimensional reinforcement structures will improve the isotropic properties of the composite material used. Also that the reinforcement will be produced from a material with higher tensile property than the matrix material, and be distributed in sufficient numbers and packing density and be of appropriate shape and size so as to enable random, mutual interpenetration, of certain regions of the three-dimensional shaped closed or three-dimensional type open structures within adjacent cell structures so as to provide an interlocking skeletal network of reinforcement to improve composite toughness and help prevent cracking or crack propagation.

These independent three-dimensional shaped structures can be easily mixed and dispersed within the matrix material to provide composite materials of improved toughness, energy adsorption, flexural strength and isotropic properties. That the resulting mechanical mixture or aggregate can be shovelled, poured, pumped, augered or ducted as necessary.

The inherent spatial relationship between the three-dimensional cell structures is dependent on the shape, type and size of the cell structure and the size of the aggregate matrix material used. That the three-dimensional shaped reinforcement structures can be manufactured from wire, bar, rod, hollow section, or fibre of various cross-sectional areas and convenient cross-sectional shapes, especially preferred are wires, fibres and bars that have a cross-section shape that can provide an interlocking (dovetail) effect. That the shaped wire, bar rod, hollow section, or fibre can be produced twisted along their axis in both left and right hand directions. (It is noted that such interlocking cross-sectional shapes (Re-tail™ reinforcing bars) can be used as two-dimensional fibre reinforcement in conjunction with the three-dimensional reinforcement described in the specification.

The features that the inventors have recognised are that the ratio of surface area to cross-sectional area of the re-entrant dovetail shaped reinforcement is significantly improved and that the increased surface area provides for improved adhesion between the reinforcement and the matrix material.

Furthermore the ratio of surface area to cross-sectional area of tubular hollow section, reinforcement is also significantly improved. In addition, it is noted that the surrounding matrix material provides resistance to buckling of such hollow section reinforcement. Three-dimensional hollow section structures will in most cases be sealed, but open-ended hollow sections or hollow sections with a number of orifices along its length can also be used as appropriate.

Throughout this specification the term ‘three-dimensional shaped reinforcement structure’ (Co-tropic™ reinforcement), will be used, unless otherwise stated, to denote all the types of three-dimensional shaped reinforcement structures made from any cross-section of wire, bar, rod, tube or organic or non-organic fibre, as described previously and therefore this term is to be construed accordingly.

The features, which the inventors have recognised, are that a dispersible/mixable, three-dimensional shaped, space cell, type structure can provide an unique type of interpenetrating reinforcement network and interrelated effect for concrete, asphalt, polymer composite and similar gel type products that helps inhibit crack initiation and helps retard crack growth. That the said, dispersible/mixable reinforcement structure helps to some extent hold the wet concrete, molten bitumen or plasticised resin together during hardening/curing against the force of gravity (slumping). That the three-dimensional shape of the said, dispersible/mixable reinforcement structure effectively prevents reinforcement failure by fibre ‘pull out’ once the composite is formed.

For example with conventional elongate fibre/whisker reinforcement it can be difficult to generate the full strength of the fibres if the fibres do not bond adequately to the matrix material. In many cases, especially when using strong metal fibres, ‘pull out’ below their ultimate tensile strength is the usual mode of failure. Given the same diameter of fibre, increases in the length of the fibre (the length: diameter ratio) will improve flexural strength and toughness of the final composite material. However, there is a limit, fibres that are too long are apt to ‘ball-up’ become less efficient and more difficult to work. Conversely dispersible/mixable, three-dimensional shaped, unit cell, closed and open structures as previously described, provide exceedingly strong anchorage within the matrix with out reinforcement ‘pull out’ or clumping.

Cylindrical or tubular shaped reinforcement mesh where the length of the cylinder can be the same as or less than or greater than the diameter. Such tubular three-dimensional structures can be produced in any cross-sectional shape i.e. oval, polygonal, or re-entrant as necessary. Unlike the use of individual fibre reinforcement the use of three-dimensional shaped (Co-tropic™) reinforcement provides secure anchorage at different orientations within the matrix material over the whole network to provide improved isotropic properties. Moreover, these three-dimensional shaped reinforcement structures are randomly positioned in close proximity to other reinforcement structures and have a beneficial and interrelated effect.

Once the matrix material sets the interpenetrating reinforcement and the interrelated affect of the reinforcement becomes substantially interlocking. This interpenetrating and subsequent interlocking effect provides three-dimensional almost omni-directional reinforcement. The skeletal network of reinforcement is particularly advantageous in preventing secondary fragmentation and crumbling of the matrix material during impact. This being especially so with respect to explosive impact in that the three-dimensional dispersible reinforcement described, helps to prevent the surrounding matrix material behaving like shrapnel. To this extend three-dimensional reinforcement as described is regarded as an explosive mitigating product.

The aspect ratio of individual conventional fibres for reinforcement must be such that the fibres are not too short as to ‘pull-out’ and not to long as to ‘ball-up’. The aspect ratio of the elements comprising the cell reinforcement structure, however, can be comparatively shorter than the length of a single fibre reinforcement, with out any risk of fibre ‘pull out’, or longer than the length of a single fibre reinforcement without ‘ball-up’.

Mixtures and combinations of different types of reinforcement structure made from different materials can be used. In addition three-dimensional shaped, space cells, as previously described can be used in combination with conventional fibre reinforcement such as carbon fibres, glass fibres, steel fibres, polypropylene and organic fibres as necessary. Used in conjunction with three-dimensional structures the use of (essentially one-dimensional) elongate fibre reinforcement will by interrelated proximity, tend to orientate in a more three-dimensional manner and also minimise any tendency towards clumping.

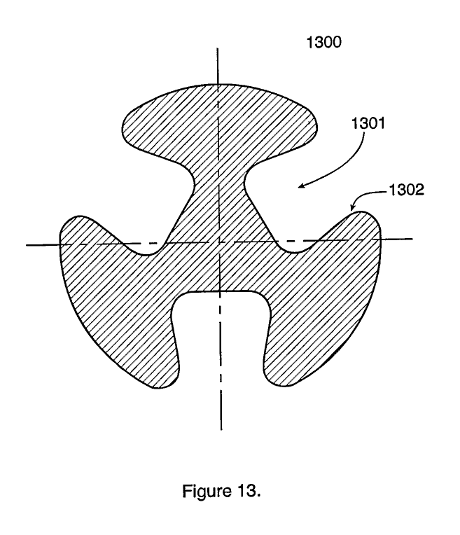

Typically, the dispersible/mixable reinforcement structure will in most cases be manufacture from wire, bar, rod, hollow section or organic or non-organic fibre products. The cross-section of the wire can be in the form of any convenient shape, such a circular, oval, elliptical, or any regular or irregular polygon with corners that have appropriate radii, such that corners or re-entrant features do not introduce sharp stress raisers within the surrounding concrete (e.g. known as the tunnel imprint). The wire product can be commercially straight or be produced with an appropriate twist. If twisted wire product is used then equal amounts of both right-hand and left-hand types of twisted wire reinforcements would be used. One preferred cross-sectional shape would be one that has a dovetail interlocking effect. It is noted that dovetail shaped reinforcement (Re-tail™) wire, bar, rod, hollow section, and fibres would be especially useful in certain application where two-dimensional fibre reinforcement products are currently used. The extruded or drawn wire feedstock when produced with the preferred re-entrant cross section (see FIG. 13) is more readily deformable during cutting to length, by cropping, shearing, guillotining or plasma or laser melt cutting, than a round cross section wire of similar area. These deformed cut ends of the re-entrant cut wire provides improved anchorage.

To reduce or eliminate corrosion the reinforcement will be made from stainless steel alloy, nickel alloy, chromium alloy, zinc galvanised steel, or non-ferrous or ferrous material, polymer, glass fibre organic or non-organic fibre, carbon fibre or polymer clad metallic material.

Furthermore, the inventors have recognised, that a dispersible, three-dimensional shaped reinforcement, while providing substantial strengthening and rigidity after the composite is hardened/cured, the slenderness (length/diameter ratio) of the space lattice allows easy dispersal within the wet, molten, or placticised matrix material with out significant plastic deformation of the original shape. Once the matrix and reinforcement have been mixed together, the matrix material completely fills the three-dimensional shaped cell structures and surrounding space with the composite mix. The inherent rheological and hydrodynamic properties of the composite mix substantially supports the individual reinforcement structure during any subsequent tamping and/or vibratory compaction stage.

The features, which the inventors have recognised, are that the addition of dispersible, three-dimensional shaped, space cells (Co-tropic™ reinforcement), effectively, provides reinforcement to regions where conventional re-bar cannot easily be applied. Moreover, the inventors also recognised that the said reinforcement provides supplementary reinforcement in conjunction to the use of conventional reinforcing-bar (re-bar).

The curing temperature of concrete has a direct influence on the rate of cement hydration and can lead to uneven distribution of heat and differential shrinkage, especially through massive concrete structures. For example ‘high-performance concrete’ can be quite sensitive to cracking, especially at early age when the concrete has yet to develop its design strength. This type of cracking can lead to premature reinforcement corrosion, concrete spalling and reduced service life. Such possibilities could nullify the purpose of using high performance concrete. Use of dispersible/mixable, three-dimensional shaped; reinforcement structures will go some way to mitigate this affect. Moreover, the interrelated network of dispersible/mixable, three-dimensional shaped, reinforcement structures made from comparatively high thermal conductivity metallic material will to some extent enable a more even distribution of heat throughout the matrix material.

The addition of dispersible/mixable, three-dimensional shaped, structures is a particularly advantageous method of reinforcement for complex shaped cast composite products and in-situ cast composite products. Moreover, it is a particularly advantageous method of reinforcement for composite products that need to be shovelled, poured, pumped augered or ducted during any stage of their application.

The invention enables the mixing of dispersible reinforcement as described previously in any temporal sequence with the matrix material.

For certain applications, the invention enables a selected addition of dispersible reinforcement eg more populated in the high stress region gradually become less populated in the low stress region.

In addition the inventors recognise that these three-dimensional shaped reinforcement structures can be manufactured by conventional means such as, twisting, knitting, weaving, punching, casting, injection moulding, and welding (typically TIG, MIG, Plasma arc, laser and Resistance welding for metallic reinforcement etc).

Applications

Examples of application for the use of dispersible, three-dimensional shaped space lattice reinforcement structures in concrete products include but are not limited to the following:
Concrete structures were conventional continuous ‘re-bar’ cannot be used.
As a supplementary reinforcement to further improve conventional continuous ‘re-bar’ applications.
Massive concrete structures where ‘early age concrete’ shrinkage/expansion induced stress can cause cracking and compromise the durability of the structure.
Particularly, roadways, driveways, towers, bridges, columns, buildings, houses, walls dams, retaining walls, high rise buildings) skyscrapers, ships and marine structures, underwater hardening concrete structures, concrete blocks, pillars, culverts, railway sleepers, embedded slab tracks, pipe-work, and similar conduits, and centrifugally cast concrete products among many others.
Asphalt roadways; (minimise the formation of undesirable road corrugations that can occur particularly where there is heavy braking), drive ways, pavements and roofs etc
Bricks, clay, ceramics and similar products.
Polymer products; centrifugally cast polymer products, boats and marine products etc.
Blast resistant chipboard and certain similar wood products.
Upgrading remote access protective structures e.g. underwater pipeline concrete covering repairs.
Fortifying existing structures to meet a security threat.
Casting into moulded configuration as a method of building walls or similar products.
Concrete products with improved fire endurance
Composite products with improved resistance to seismic effects
Structures produced by concrete pumped, sprayed, augered or ducted where mixable reinforcement is required.

### EXAMPLES

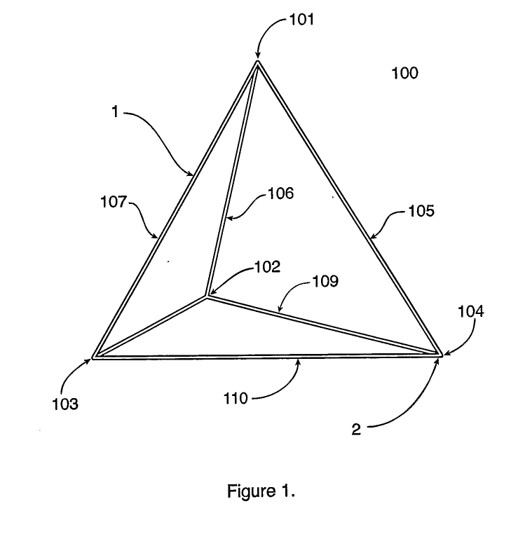

With reference to FIG. 1 herein there is shown a reinforcement means 100. This reinforcement means 100 comprises four apices 101, 102, 103 and 104 respectively each of these apices is connected to each other via a substantially rigid member 105, 106, 107, 108, 109 and 110 respectively. Each of these substantially rigid members 105, 106, 107, 108, 109 and 110 respectively is of a substantially identical dimension according to this first specific embodiment of the present invention. This arrangement of four apices and six substantially rigid connecting members forms a regular four-sided pyramid structure. The inventors consider a regular pyramidal structure to be particularly suitable as a reinforcing means, as given the extremely regular nature of the object it is very well suited to the absorption and dissipation of forces which may act upon it.

According to this first specific embodiment of the present invention the reinforcement means is made from steel. In addition to steel the inventors also consider it possible to use many other metallic and non-metallic materials, the most important characteristic of the selective material is that it has a higher tensile strength than the material which it is reinforcing. Such that if force is applied to the material that is being reinforced these forces are dissipated and absorbed by the reinforcing means.

A number of other geometric shapes are also possible for the implementation of this invention and the preferred these will be discussed as further embodiments of the present invention.

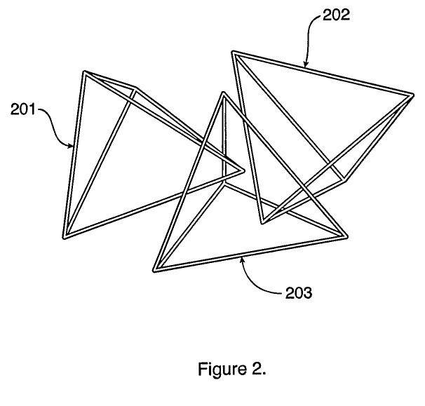

With reference to FIG. 2 herein there is shown a plurality of reinforcement means 201, 202 and 203 respectively. A plurality of reinforcement means is able to reinforce a greater portion of a reinforced material than a single reinforcement means. In use this plurality of reinforcement means is disbursed as evenly as possible throughout the material which is to be reinforced. As this plurality of reinforcement means comprises four apices connected by substantially rigid numbers each reinforcement means of this plurality is able to interact with another reinforcement means and at least partially insert into each other. By allowing the plurality of reinforcement means to intersperse in this way this allows the reinforcements means to disperse more evenly throughout the material which is being reinforced.

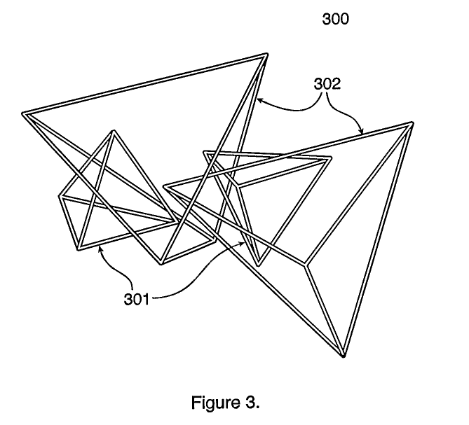

With reference to FIG. 3 herein there is shown a plurality of reinforcement means 300, this plurality of reinforcement means again comprises regular triangular four sided pyramids but of different sizes. By providing a plurality of reinforcement means of different sizes this allows the smaller reinforcement means 301 to interpose with larger reinforcement means 302 fully and further aids the dispersal of the various subtypes of the reinforcement means throughout the material which is being reinforced.

In accordance with further embodiments of the present invention its possible that the plurality of reinforcement means may comprise different sized versions of the same or different shaped reinforcement means. The inventors consider it useful to have a plurality of different sized and shaped reinforcement means making up the reinforcement means so as to maximise the reinforcement of the material.

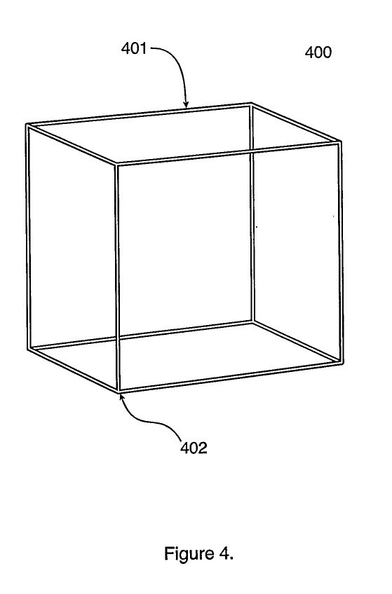

With reference to FIG. 4 herein there is shown a further embodiment 400 of the present invention. In accordance with this further embodiment of the present invention there is provided a reinforcement means 400. The reinforcement means according to this specific embodiment of the present invention is formed from wire pieces 401 connected to each other so as to form a substantially cuboid structure. This structure comprises eight apices 402, each of which is connected to three other apices via substantial straight supporting limbs.

The inventors consider this type of substantially cuboid reinforcement means to be useful as the presence of the multiple supporting limbs supporting the opposing faces of the cuboid give the reinforcement means a great deal of structural rigidity and strength and allow the structure to reinforce any material into which it is introduced.

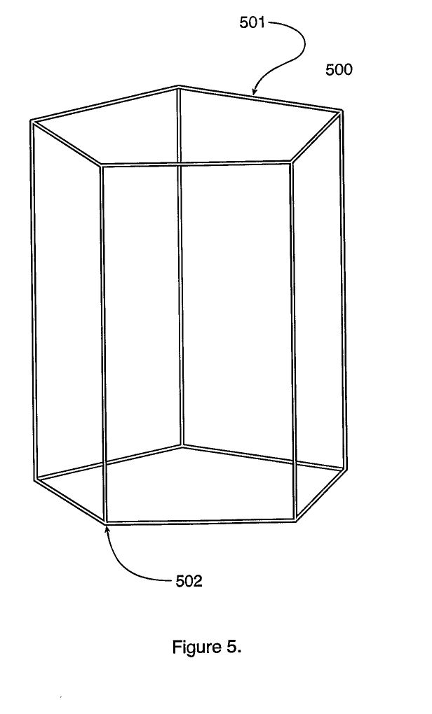

With reference to FIG. 5 herein there is shown a reinforcement means comprising first and second side. These first and second sides 501 and 502 respectively being in the form of five sided regular pentagons. The apices of each pentagon are connected to one other apice of the other pentagon side via a straight substantially rigid member.

In accordance with this further embodiment of the present invention therefore the inventors provide reinforcement means which may comprise one or more sides of any regular or irregular geometric shape connected to another side via substantially straight members.

As with previous embodiments of the present invention this reinforcements means 500 is made from a substantially rigid material. This combination of sides formed into regular geometric shapes and members connecting the two or more sides of this reinforcement means provides this reinforcement means with a great deal of structural rigidity and strength which when the reinforcement means is interspersed into a material in parts this increased structural rigidity and tensile strength to the material being reinforced.

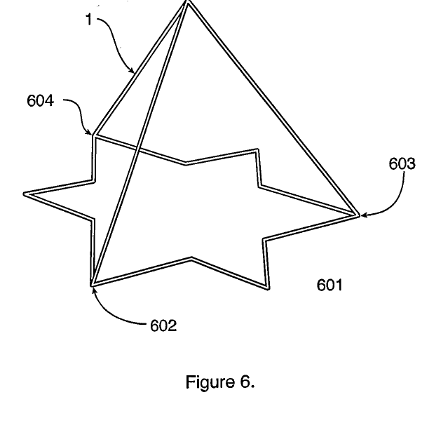

With reference to FIG. 6 herein there is shown a further embodiment of the present invention. In accordance with this further embodiment there is shown a substantially planar Star of David or six-sided star shape 601. Projected from three apices 602, 603 and 604 respectively of this first shape are three substantially linear and rigid members that project to a single point in a plain above the shape.

The inventors provide a combination of a single geometric shape and a number of substantially linear connecting members in this instance connecting to each other and not to another geometric shape. By providing this combination of substantially plain art geometric shape and a number of rigid members forming a three dimensional structure this further embodiment of the present invention is capable of reinforcing materials into which it is introduced.

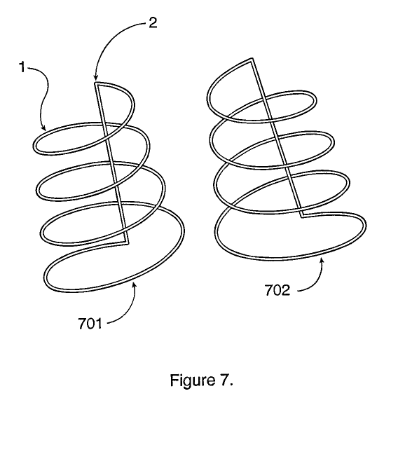

With reference to FIG. 7 herein there is shown a reinforcement means according to a further embodiment of the present invention there is shown a substantially helical member connected on either end thereof to a substantially rigid linear member. According to this specific embodiment of the present invention there is provided both a left handed 701 and right handed 702 version of this embodiment.

As discussed previous by providing left and right handed embodiments of this particular type of reinforcement means this reduces likelihood that individual members of the plurality of reinforcement means will interact with each other such an extent that they begin to clump and therefore and be dispersed as fully as possible in the material that is being reinforced. As with previous embodiments of the present invention the reinforcement means in accordance with this specific embodiment are made from substantially rigid materials such that the structural rigidity and strength of these reinforcement means when introduced into a material reinforces the material and increases its tensile and other mechanical properties.

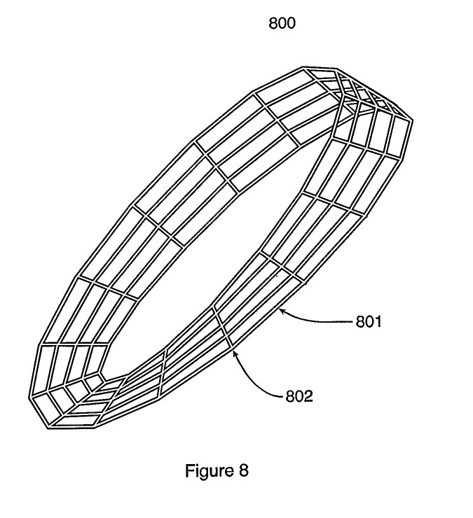

With reference to FIG. 8 herein there is shown a Mobius strip 800. This structure comprises a number of substantially linear members 801 arranged into a parallel formation with each other via a number of perpendicularly opposed supporting members 802 which are also substantially linear. Also the structure formed by these substantially parallel and perpendicular members is folded such that the interior surface of the structure becomes the exterior surface of the structure along the length of the structure.

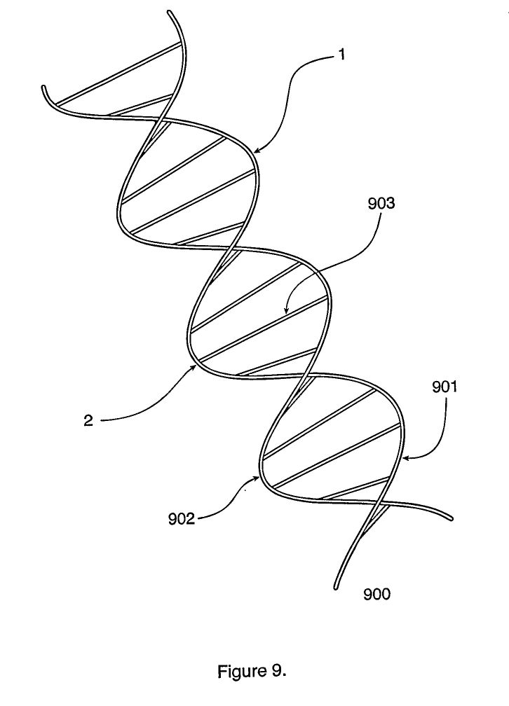

With reference to FIG. 9 herein there is shown is further type of reinforcement means according to a further embodiment of the present invention. In accordance with this embodiment there is provided a double helical structure 900 comprising two strand members 901 and 902 helically wound around each other and connected by a number of cross linking members 903 to the two helically inter-wound strands. In addition to the right helical structure depicted in FIG. 9 it is also possible to provide a left helical structure so producing the anti-clogging properties using a mixture of left and right handed versions of the reinforcement means.

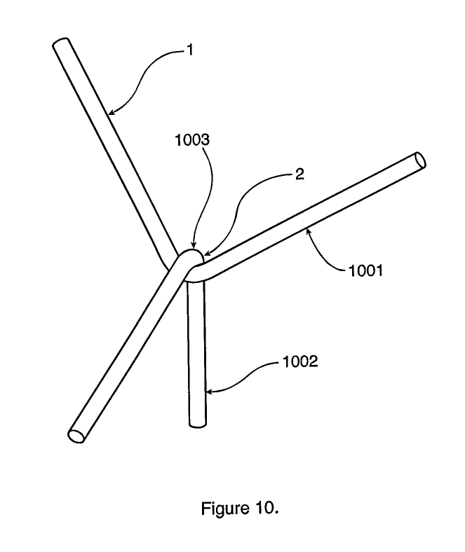

With reference to FIG. 10 herein there is shown a further reinforcement means. In accordance with this further embodiment of the present invention there is provided a reinforcement means which comprises a first substantially linear member 1001 which has been bent in a middle portion thereof and connected to this first substantially linear member is a second substantially linear member 1002 which has also been bent in or about its middle. These two substantially linear members are connected to each other in a permanent fashion and in the case of this specific embodiment of the present invention being made from metal these two member are connected via a weld 1003. This very simple reinforcement means comprising two end pieces of material connected to each other is very economic to manufacture and quick and easy to produce in large numbers.

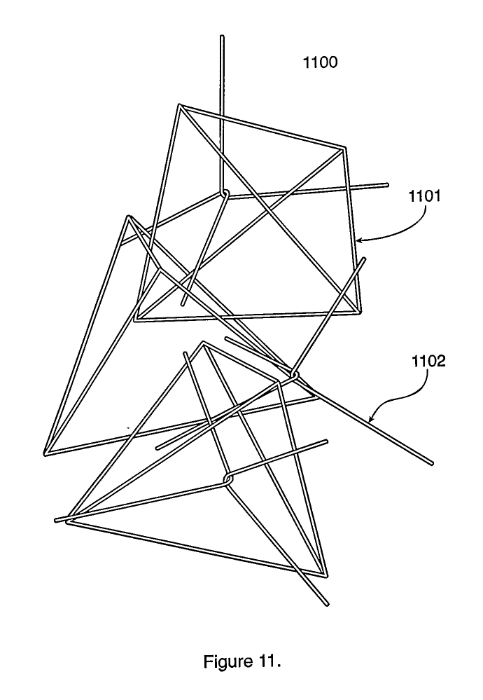

With reference to FIG. 11 herein there is shown a plurality of reinforcement means 1100 in accordance with several of the embodiments of the present invention in particular there is shown several pyramidal enforcement means 1101 in combination with several enforcement means comprising two substantially linear members 1102 joined in their middle regions and bent so as to produce three dimensional structures. This combination of reinforcement means increases the likelihood that the reinforcement means will be disbursed as fully as possible throughout the material which is being reinforced.

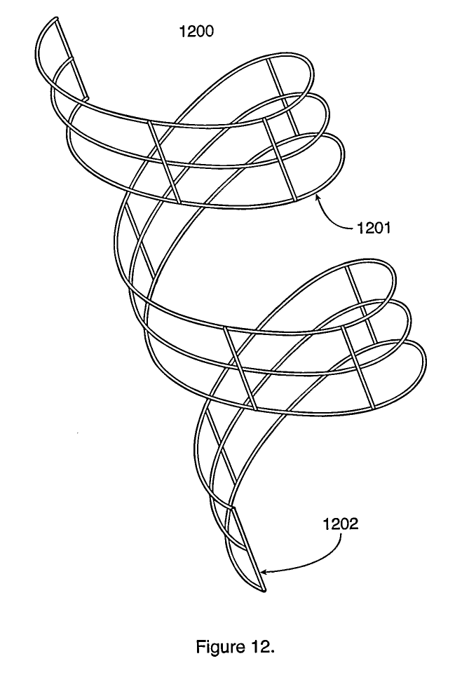

With reference to FIG. 12 herein there is shown a further embodiment of the present invention and in accordance with this further embodiment of the present invention there is provided a single helical structure 1200 comprising three substantially linear members 1201 in a helical arrangement connected and spaced apart from each other via the number of perpendicularly arranged supporting members 1202. As with previous embodiments of the present invention this triple helical structure can be produced in either left or right handed variants and the number of helical strands that make up structure can be increased or decreased as appropriate to the specific reinforcement job for which the structure is required.

With reference to FIG. 13 herein there is shown a further embodiment of the present invention in accordance with this further embodiment of the present invention there is provided a further type of reinforcement means 1300 which is shown in cross section in FIG. 13. This reinforcement means 1300 comprises a number of lumen 1301 formed into the reinforcement means 1300 and configured to as to receive material into which the reinforcement means 1300 is introduced. Each of these lumen 1301 has associated with it an aperture 1302 through which material can pass into and out of its associated lumen 1301. The dimension of the lumen 1301 is greater than the dimension of the associated aperture 1302. When material has solidified in the interior of the lumen 1301 therefore it is difficult for such material to be extracted from the lumen 1301 via its associated aperture 1302 as the volume of the solidified material is greater than the dimension of the aperture 1302 so anchoring in place the reinforcement means inside of a material which is being reinforced.

In accordance with this specific embodiment of the present invention there are provided three lumen in the reinforcement means in accordance with further embodiments of the present invention the number of lumen may increase of decrease from this number. In addition this embodiment of the present invention may either be in the form of a series of substantially disc structures or alternatively the cross section may be part of a elongate structure which can be formed into any of the other embodiments of the invention previously described.

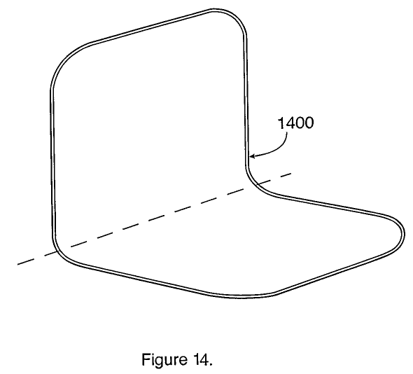

With reference to FIG. 14 seen herein there is shown a further embodiment of the present invention which comprises a closed loop structure 1400 of a substantially square shape which has been folded such that one half of the structure projects above the plane upon which the rest of the structure rests.

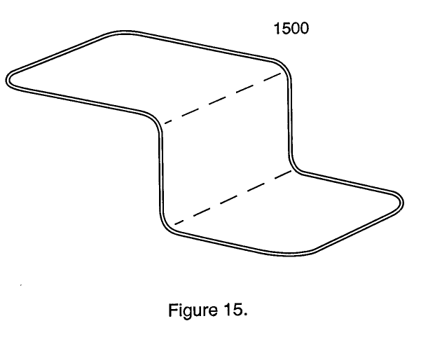

With reference to FIG. 15 herein there is shown a further embodiment of the present invention, there is provided a reinforcement means 1500 again which comprises a closed loop structure which if present on a single plane would be substantially square. The structure however has been bent such that approximately a middle portion of the reinforcement means has been bent so as to projected above the plane of a first portion at a perpendicular angle and then bends again so as to be substantially parallel to this first portion but to rest in a different higher plane from it.

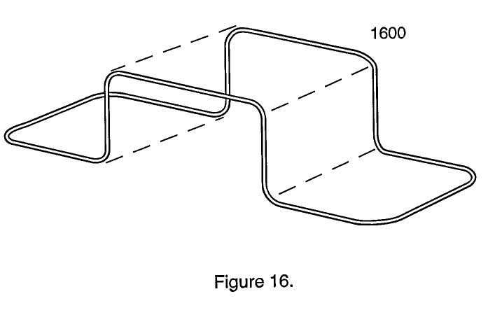

With reference to FIG. 16 herein there is provided a further embodiment of the present invention there is shown a reinforcement means 1600 which again comprises a closed loop structure whose form comprises a first and last portion on a first plane and a middle portion on a higher plane relative to the first plane. This middle portion being connected via a first and second substantially perpendicular portions to these planes and connecting the first, middle and last portions to each other respectively.

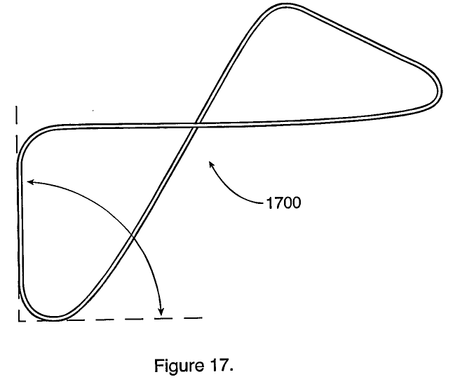

With reference to FIG. 17 herein there is provided a further embodiment of the present invention wherein there is shown a reinforcement means 1700 again of a closed loop structure which has been twisted so as to project into three dimensions.

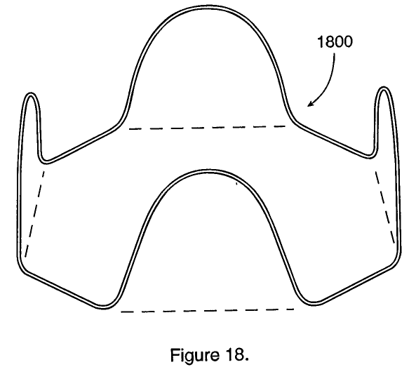

With reference to FIG. 18 herein there is shown a further embodiment of the present invention and there is provided a reinforcement means 1800 again of a closed loop variety with a series of substantially semicircular projections up from plane upon which the structure rests.

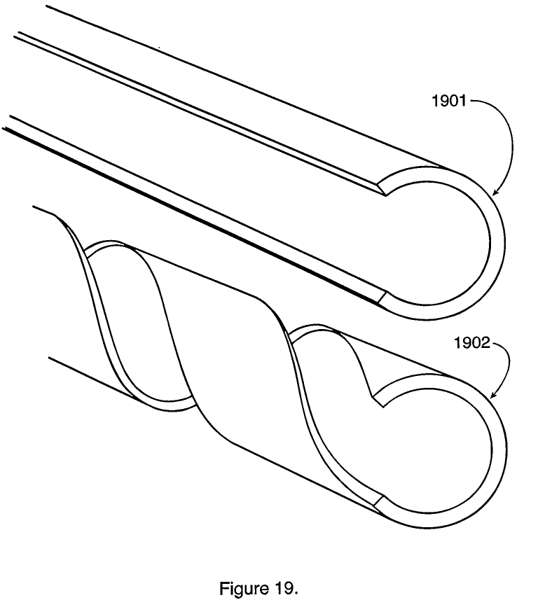

With reference to FIG. 19 herein there is shown a number of further structures which comprise lumen and associated apertures which can either form reinforcement means per se or alternatively can be formed into any of the structures previously described as previous embodiments of the present invention. There is provided either an open tube structure 1900 or alternatively a spiral tube structure 1901 which may be provided in either a left of right handed variant.

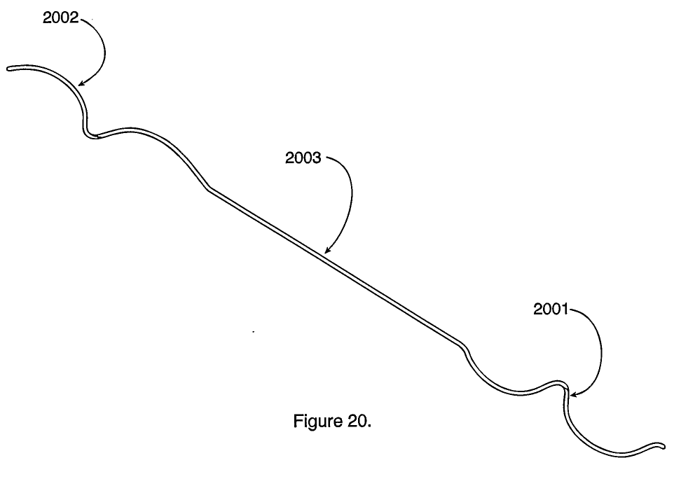

With reference to FIG. 20 herein there is shown a further embodiment of the present invention which comprises a reinforcement means made from a substantially linear piece of material into which is formed at a first end a right handed helix 2001 and at a second end a left handed helix 2002 the left and right handed helices are connected by an intermediary portion 2003.

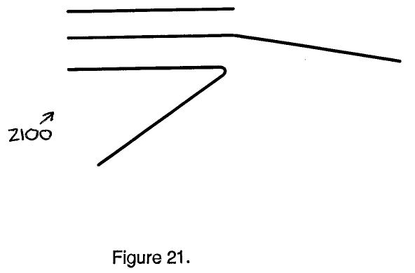

With reference to FIG. 21 herein there is shown a further embodiment of the present invention. In accordance with this further embodiment there is provided a reinforcement means which comprises a single piece of substantially elongate material 2100. This piece of elongate material has been bent in a substantially medium portion so as to project into substantially three dimensions and so interact with a greater volume of the material into which this reinforcement means 2100 has been introduced. In accordance with this further embodiment of the present invention this substantially elongate reinforcement means 2100 may be made from a number of materials such as metal wires or plastic chords. In addition the elongate reinforcement means 2100 may comprise a set of lumen and associated apertures as previously discussed so as to increase the anchoring of such a reinforced member in the material which is being reinforced. Further, in use a plurality of such elongate reinforcement members would be used and this plurality of elongate reinforcement members may comprise a mixture of left and right handed versions of these elongate reinforcement members.

1-67. (canceled)

68. A reinforcement means comprising a plurality of substantially identical structures, characterized in that said plurality of structures comprise a mixture of right and left hand structures.

69. A reinforcement means according to claim 68, wherein each of said plurality of structures is substantially rigid.

70. A reinforcement means according to claim 68, wherein said plurality of structures comprise substantially one dimensional member fabricated so as to extend in three dimensional space.

71. The reinforcement means according to claim 70, wherein said substantially one dimensional member comprises an open linear form.

72. A reinforcement means according to claim 68, wherein said substantially one dimensional member comprises a substantially closed loop arrangement fabricated into a three dimensional structure.

73. A reinforcement means according to claim 72, wherein said three dimensional structure comprises a substantially one dimensional member fabricated into a three dimensional form, the ends of which are not connected.

74. A reinforcement means according to claim 72, wherein said three dimensional structure is fabricated from a substantially one dimensional member into a closed loop three dimensional structure.

75. A reinforcement means according to claim 68, wherein said substantially one dimensional member comprises a substantially helical form.

76. A reinforcement means according to claim 68, further comprising at least one lumen and an associated aperture, characterized in that the maximum dimension of said at least one lumen is greater than the maximum dimension of said associated aperture.

77. A reinforcement means according to claim 76, wherein each said at least one lumen is substantially enclosed by the material into which it is formed and is accessible only via said associated aperture.

78. A reinforcement means according to claim 76, wherein each said at least one lumen is substantially open and comprises more than one associated aperture, wherein a maximum dimension of said at least lumen is greater than a maximum dimension of said each associated aperture only in one plane.

79. A reinforcement means according to claim 76, wherein said lumen is formed into a substantially elongate member.

80. A reinforcement means according to claim 76, wherein said at least one lumen and said associated aperture are formed into a substantially two dimensional structure.

81. A reinforcement means according to claim 80, wherein said substantially two dimensional structure is in the form of a disc.

82. A reinforcement means according to claim 68, wherein said substantially closed structure defines a three dimensional geometric shape, said three dimensional geometric shape being characterized in that said shape comprises at least four apices and wherein each of said apices is connected to at least three other said apices by at least one substantially one dimensional member.

83. A reinforcement means according to claim 82, wherein said three dimensional geometric shape is regular, comprising substantially uniform sides.

84. A reinforcement means according to claim 82, wherein said three dimensional geometric shape is irregular comprising side portions of different number of sides.

85. A reinforcement means according to claim 82, wherein said substantially one dimensional members define planar sides of said three dimensional geometric shape.

86. A reinforcement means according to claim 68, wherein said reinforcement means comprise a mixture of different sized structures.

87. A reinforcement means according to claim 68, wherein said reinforcement means is configured for use with at least one material selected from the group comprising concrete, a resin, asphalt, polymer materials and a gel material.

88. A method of reinforcing a material, comprising the step of introducing reinforcement means in said material, said step using reinforcement means further comprising the introduction of a plurality of substantially identical structures into said material, said plurality of structures comprising a mixture of right and left hand structures.

89. A method of reinforcing a material according to claim 88, wherein said reinforcement means comprises at least one lumen and an associated aperture, wherein in a maximum dimension of said at least one lumen is greater than a maximum dimension of said associated aperture.

90. A method of reinforcing a material according to claim 88, wherein said reinforcement means comprises at least one three dimensional geometric shape, said shape comprising at least four apices and wherein each of said apices is connected to at least three other of said apices by at least one substantially one dimensional member.

91. A kit of parts for a reinforcement means, wherein said reinforcement means comprises at least one lumen and an associated aperture, characterized in that a maximum dimension of said at least one lumen is greater than a maximum dimension of said associated aperture.
